(19) United States
(12) Patent Application Publication
(10) Pub. No.: US 2007/0257817 A1
(43) Pub. Date: Nov. 8, 2007

(54) Traffic signal system with countdown signaling and with advertising and/or news message

(75) Inventor: Jerome R. Mahoney, Colts Neck, NJ (US)

Correspondence Address: Kenneth P. Glynn, 24 Mine Street, Flemington, NJ, 08822, US

(73) Assignee: iVoice, Inc.

(21) Appl. No.: 11/429,863

(22) Filed: May 8, 2006

(51) Int. Cl. G08G 1/096

(52) U.S. Cl. 340/929

(57) ABSTRACT

A traffic signal includes, minimally, at least one traffic signal located at a motor vehicle crossing that includes (i) a traffic signal light that includes at least a red light; (ii) a countdown display that visually indicates relative or actual time remaining before a signal change is to occur; and (iii) a message display for presenting messages in a changing fashion to present messages that are not countdown information. The traffic light control is connected to the traffic signal and includes (i) a control for turning the red light off and on in accordance with preset criteria; (ii) a countdown control connected with the light control and connected to the countdown display, and set to present time remaining before a signal change is to occur; and (iii) a message control connected to the message display to control the presentation of the messages.

### BACKGROUND OF INVENTION

a. Field of Invention

The invention relates generally to traffic signal systems for motor vehicle traffic controls at road intersections and other crossings that include at least one stop/go light signal, minimally having a red light and a green light, but typically having a red, a yellow (or amber or orange), and a green light. The present invention system further includes a countdown signaling feature so that a driver may see a signal that illustrates actual or relative time left before a light changes. This countdown is preferably to indicate to an oncoming vehicle with a green light how much relative or actual time is left before the light turns red, but it could signal time left on a yellow or red light or any combination of any of the foregoing. The present invention system further includes a message presentation area for a driver to read, at least while at a red light. The message presentation is preferably news and or advertising, but could be jokes, streaming of a media broadcast or any other message. Thus, the system provides a message that is different from countdown information and presents opportunities for public and private sector entertainment and information. The system would be an information (including news and/or advertising) and entertainment provider for any intersection requiring traffic signals, and would be outstanding additions to railroad crossings, draw bridges and any other traffic stop areas where waits are protracted and otherwise annoying to the driver.

b. Description of Related Art

The following patents are representative of enhancements to traffic signal systems:

U.S. Pat. No. 6,989,766 B2 to Mese et al teaches broadcasting traffic signal data is broadcast, for receipt by vehicles traversing the roadways controlled by the traffic signals. If desired, traffic lights are provided with the capability to broadcast their location, status, changing cycles and timing data continuously. A receiving system in a vehicle is configured to receive the traffic signal data and display, to a user of the vehicle, visual display information and/or audible information informing the user of a speed range which, if followed, optimizes the use of the highway and minimizes the number of starts and stops that must be made.

U.S. Pat. No. 6,380,867 B1 to Maull describes a traffic light sequence indicating time remaining before signal light changes. The traffic light sequence indicating system includes a housing. The housing has a front wall, a back wall, a top wall, and a bottom wall. Control circuitry is mounted in the housing and is operationally coupled to the traffic light controller and adapt to time traffic light sequences. A first display displays information from the control circuitry. A surface of the first display is generally flush with a surface of the front wall. The first display is operationally coupled to the control circuitry. The control circuitry displays indicia indicating minutes and seconds on the first display. A fastening means removably fastens the top wall to the arm of the traffic light system.

U.S. Pat. No. 6,331,824 B1 to Firestone describes a transparent lens for motorist traffic light signals and pedestrian “Don't Walk” signs that displays, in LED countdown “real-time”, how much time remains before the traffic signal command will change. The lens is easily shaped to be adapted over any existing traffic control device or magnified over the exiting control device and works in conjunction with existing technology for timing and control settings to provide a quick and economical installation. The covering lens is a traffic light signaling device combination manufactured as one assembly and comprised of known colored liquid crystal (LED), plasma or pixel generators or other imaging generating technology which is quickly affixed to existing signal traffic devices.

U.S. Pat. No. 6,268,805 B1 to Simon teaches an apparatus for the control of traffic that includes a signal assembly with a red stoplight, a green passage light, and a yellow caution light. A count-down indicator includes a digital display that displays (i.e., count downs) the remaining time in seconds until the next signal change occurs. The digital display matches the color of the digits being displayed to that of the illumined light of the signal assembly. The count-down indicator includes a battery backup assembly that includes an optional backup battery that permits functioning of the traffic signal during power outages. An optional solar panel economically helps maintain the charge of the backup battery. A microprocessor in the battery backup assembly receives information from the signal assembly, processes that information, and controls the digital display parameters. If the signal assembly relies upon traffic sensors and can abruptly change the remaining time that is being shown by the digital display, the digits of the digital display flash to inform a driver of this potentiality. According to a modification, a flashing caution light is attached to the digital display and it flashes when there is a potential that the remaining time can suddenly change in a manner that violates normal countdown sequence.

U.S. Pat. No. 5,726,648 to Soon describes a time indicating traffic light.

U.S. Pat. No. 4,059,821 to Nichols describes a traffic signal controller flasher for pedestrian clearance.

Notwithstanding the prior art, the present invention is neither taught nor rendered obvious thereby.

### SUMMARY OF INVENTION

The invention solves the problems and overcomes the drawbacks and deficiencies of prior art with countdown features by providing visual information, advertising and/or entertainment to a driver while waiting at a red light.

The present invention traffic signal system with countdown signaling and with message, in its basic terms, includes at least one traffic light, a traffic light control means and a message display control means. Thus, minimally, there is at least one traffic signal located at a motor vehicle crossing that includes (i) a traffic signal light that includes at least a red light; (ii) a countdown display that visually indicates relative or actual time remaining before a signal change is to occur; and (iii) a message display for presenting messages in a changing fashion to present messages that are not countdown information. The traffic light control means is connected to the traffic signal and includes (i) light control means for turning the red light off and on in accordance with preset criteria, such as time light changes, an approaching train at a crossing that is automatically signaled in conventional manners, a draw bridge that is closed by manual operation, etc.; (ii) countdown control means connected with the light control means and connected to the countdown display, and set to present time remaining before a signal change is to occur; and (iii) a message control means connected to the message display to control the presentation of the messages.

The traffic light is at least a red light that signals to stop when it is lit and to go when it is not lit. Lights with one red and one green are also included. Standard three light systems of red, yellow (or its equivalent) and green are also included. Interconnected sets of lights at a single intersection are likewise contemplated, as are systems with a plurality of lights at a plurality of different intersections or crossings. Also, entire municipal or other jurisdictional traffic light systems are contemplated within the scope of the present invention.

The signal light controls are any conventional or available subsystems, and are well within the skill of the artisan. These include individual intersection signal processor controllers that are programmed with set timers, more advanced controllers that have more complex programming, e.g. different light timing patterns for morning, off peak and evening traffic, and remote computer controlled systems. These systems are used to maximize the use of light signal timing and sequencing to suit real time traffic flow needs.

The countdown displays may be a series of bars or other symbols that are lit when a light turns green and go out to indicate relative time left before the light changes, e.g. five red bars are lighted for a thirty second green light; when only 24 seconds are left, one bar goes out; when 18 seconds are left, a second bar goes out and so forth indicating relative time left for the driver to reach the intersection and safely cross it. Alternatively, the countdown display may be a visual presentation on numerical representation of seconds left before the light changes. These could be in one, two or five second intervals, for example. The coordination of these countdown displays and control thereof with the true timing of the light changes is well known and set forth in the prior art cited above.

The message display is attached to or within the housing of the signal light and may be any type of lighted message box or screen, including LCD, LED, plasma, etc. including but not limited to known television, computer screen and moving message sign technologies. Likewise, inputs may be computer controlled, e.g., with repeat cycles or continuous messages, such as streaming radio and/or captioned TV. In most preferred embodiments, the messages are selected from the group consisting of entertainment messages, news messages, information messages, public information and announcement messages, advertising and combinations thereof.

The display presentation may have any sequencing, varying or fixed length and any desired content, although in some preferred embodiments, the messages may run only during the first 90% of the time a red light is on and then the message may stop so that drivers may ready themselves for driving when the light switches. This embodiment prevents both delays and distractions during actual driving. In some preferred embodiments, the messages on the message display are selected from the group consisting of graphic images, words and combinations thereof. The graphic image possibilities run from fixed light displays and moving light displays such as are seen in Times Square, New York, for example, to full captioned image displays like such as short digital movies and TV. While it is contemplated that many of the messages will be streaming words, in other embodiments, the messages are presented in sequential groups of messages or sequential portions of messages, displayed for one or a few seconds and replaced.

In some preferred embodiments, the messages are transmitted display of motion presentation with closed caption. Thus, the motion presentation may be a closed caption presentation selected from the group consisting of video, computer generated motion presentation and television. In some preferred embodiments, the traffic signal light includes at least a red light and a green light and the countdown display functions when the green light is lit and the message display functions when the red light is lit.

In some preferred embodiments, the message display control means includes a government override feature for public emergency messages to supercede normal message display. Thus, a normal message may be overridden by a governmental person, authority or even automatic system to send an emergency message, e.g., a police chase or ambulance is approaching, or an accident has occurred ahead, etc.

The display control means may be any known or available system for placing a changing message on a screen or message board. Thus, within the scope of the present invention at one end of the spectrum are simple systems that merely require messages typed into a processor and sent, or digitally recorded; to be wired to or wirelessly sent to a screen or board. (From this point forward, the term “screen” will be used to mean any type of presentation screen, board, light array, light box, message box or the like.) At the opposite end of the spectrum is a significant server or servers with hardware, software and transmission capabilities to control, monitor and transmit to a plurality of traffic signal units at multiple crossings, e.g., for an entire city, county, roadway, waterway, railway or any segment or combination thereof, and may include color, video or fixed artwork along with words, and, as indicated, could be streaming newscasts, sportscasts, or any other message, e.g., jokes, health hints, political, sports and community events (coverage or schedules), local, state, national, international news, movie trailers, advertising, sponsored event announcements, local school news or any other topic that the user or government may desire or authorize. While line transmissions are possible and stand alone lines could be used or takeoffs could come from electric, cable TV or telephone line connections, wireless transmission is one preferred embodiment that could utilize existing technology, such as text messaging, streaming, photo and video transmissions now used widely, for example, with cell phones and PDAs.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 is a front view of one preferred embodiment of a traffic signal system according to the present invention, illustrating a single signal unit and controller microprocessor;

FIG. 2 is a perspective view of an intersection with a present invention system traffic signal four way unit;

FIG. 3 is an enlarged front view of a traffic signal unit of the present invention system wherein captioned video, pictorial and word advertising and other complex presentations beyond word streams are included; and,

FIG. 4 shows a diagrammatic presentation of a present invention macrosystem for multiple crossings with multiple features.

### DETAILED DESCRIPTION OF THE EMBODIMENTS

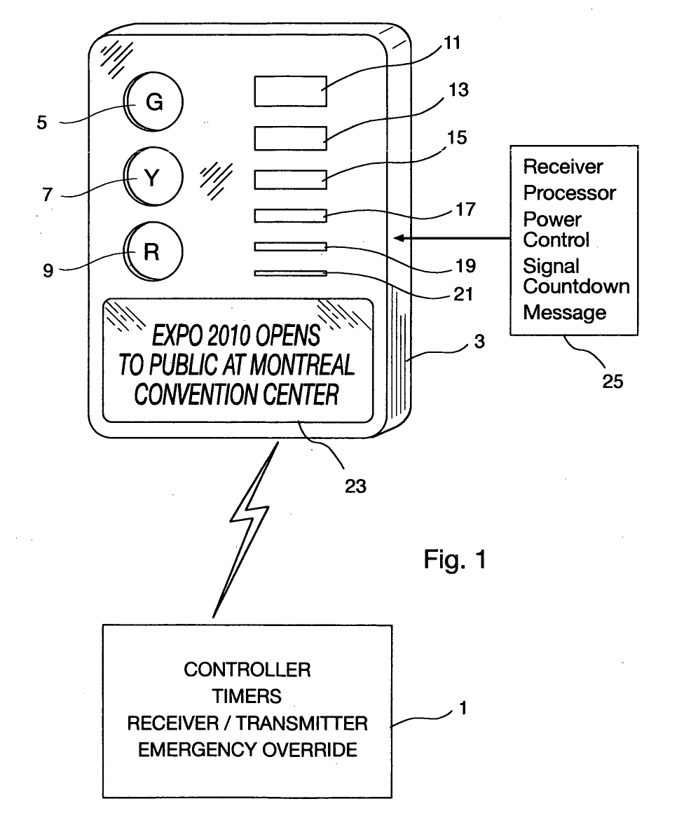

Referring now to the drawings, the present invention system is further illustrated by example. Thus, FIG. 1 illustrates a front view of one preferred embodiment of a traffic signal system according to the present invention, illustrating controller 1, typically a microprocessor, and a single traffic signal unit 3. Unit 3 has a green light 5, an amber or yellow light 7 and a red light 9, that operate in conventional stop light sequence with timing either preset for a single sequence or programmed for traffic patterns and direction. Unit 3 includes a message display means, here, screen 23. There is also a bar display with a plurality of illuminateable bars 11, 13, 15, 17, 19 and 21. These illuminate in full lighted display when the green light 9 comes on and are sequentially shut off as time elapses. One method involves having these shut off in equal time sequences even thought the bars are of decreasing size. For example, a 42 second green light would have this countdown display change every 6 seconds, as follows:

| TIME LAPSE SINCE | | |
|---|---|---|
| LIGHT TURNS GREEN | COUNTDOWN EVENT | MESSAGE EVENT |
| Red light on/G, Y off | All bars 11-21 off | Message streaming |
| Green light on/R, Y off | All bars 11-21 on | Message stopped |
| 0 to 7 seconds G on | All bars 11-21 on | ″ |
| 7 to 14 seconds G on | Bar 11 off/13-21 on | ″ |
| 14 to 21 seconds G on | Bars 11-13 off/15-21 on | ″ |
| 21 to 28 seconds G on | Bars 11-15 off/17-21 on | ″ |
| 28 to 35 seconds G on | Bars 11-17 off/19, 21 on | ″ |
| 35 to 42 seconds G on | Bars 11, 19 off/21 on | ″ |
| At 42 seconds, Y on, R, | All Bars 11-21 off | ″ |
| G off | | |
| At 46 seconds R on, G, | All Bars 11-21 off | ″ |
| Y off | | |
| Sequence Repeats: | | |
| 46 to 88 seconds, Red | All bars 11-21 off | Message streaming |
| on etc. | | |

In an alternative embodiment, the countdown bars are not shut off in equal time frames (i.e. are not linear) and a progressive, or accelerating shut off rate is used. Such a sequence could be as follows:

| TIME LAPSE SINCE | | |
|---|---|---|
| LIGHT TURNS GREEN | COUNTDOWN EVENT | MESSAGE EVENT |
| Red light on/G, Y off | All bars 11-21 off | Message streaming |
| Green light on/R, Y off | All bars 11-21 on | Message stopped |
| 0 to 12 seconds G on | All bars 11-21 on | ″ |
| 12 to 21 seconds G on | Bar 11 off/13-21 on | ″ |
| 21 to 28 seconds G on | Bars 11-13 off/15-21 on | ″ |
| 28 to 34 seconds G on | Bars 11-15 off/17-21 on | ″ |
| 34 to 39 seconds G on | Bars 11-17 off/19, 21 on | ″ |
| 38 to 42 seconds G on | Bars 11, 19 off/21 on | ″ |
| At 42 seconds, Y on, R, | All Bars 11-21 off | ″ |
| G off | | |
| At 46 seconds R on, G, | All Bars 11-21 off | ″ |
| Y off | | |
| Sequence Repeats: | | |
| 46 to 88 seconds, Red | All bars 11-21 off | Message streaming |
| on etc. | | |

In yet another example, all of the bars stay lit for a portion of the green light before sequencing begins, as, for example:

| TIME LAPSE SINCE | | |
|---|---|---|
| LIGHT TURNS GREEN | COUNTDOWN EVENT | MESSAGE EVENT |
| Red light on/G, Y off | All bars 11-21 off | Message streaming |
| Green light on/R, Y off | All bars 11-21 on | Message stopped |
| 0 to 25 seconds G on | All bars 11-21 on | ″ |
| 25 to 30 seconds G on | Bar 11 off/13-21 on | ″ |
| 30 to 33 seconds G on | Bars 11-13 off/15-21 on | ″ |
| 33 to 36 seconds G on | Bars 11-15 off/17-21 on | ″ |
| 36 to 39 seconds G on | Bars 11-17 off/19, 21 on | ″ |
| 39 to 42 seconds G on | Bars 11, 19 off/21 on | ″ |
| At 42 seconds, Y on, R, | All Bars 11-21 off | ″ |
| G off | | |
| At 46 seconds R on, G, | All Bars 11-21 off | ″ |
| Y off | | |
| Sequence Repeats: | | |
| 46 to 88 seconds, Red | All bars 11-21 off | Message streaming |
| on etc. | | |

These various examples show how sequencing can be designed to achieve an effective aide to drivers. In place of the bars shown in FIG. 1 could be any symbolic countdown presentation, different shapes, such as squares or circles, dimming sequence(s), or other visual symbolic countdown designs can be used. Real time digital displays can be used instead of or in addition to the symbolic countdown displays mentioned.

FIG. 1 also shows controller 1 that includes programmable capabilities for the timers (signal lights, countdown mechanism and display and message mechanism and display), as well as to receive and transmit the messages displayed on the screen 23 of unit 3. Controller 1 may receive messages in any fashion, e.g., manually (typed into the processor), digitally (disc or otherwise), electronically or otherwise, either via wire, wirelessly or a combination of both. Likewise the transmission of the message may be by wire or wirelessly transmitted. Thus, the controller 1, in this embodiment, includes a transmitter and a receiver, and may receive from third party locations, such as a TV studio transmitter, from the traffic light unit 3, or both, and minimally transmits to the unit 3. Unit 3 has a corresponding receiver that is connected to the lights (or the lights may be on a separate controller) and to the countdown display and to the message display. Whether the receiver 25 is separate from the controls for the lights, the countdown and/or the message display or all of this is accomplished from a single receiver is not important. However, it is important that the mechanisms for controlling the lights, the countdowns and the messages be coordinated and cooperative so that their respective functions are harmonized, that is, so that the countdown coincides with the timing of the light changes and that the messages are presented to the drivers at the lights and usually while they are at a stop.

Thus, the present invention system essentially includes means to provide a visual countdown for a light change, and means for sending changing messages to a traffic signal and means to present the message at the traffic signal for the drivers to view. The presentation at the traffic signal has the synergistic effect of providing a driver with information, amusement or advertising while keeping the driver's eyes on the signal. In preferred embodiments, the messages are presented only when a light is red so as not to distract a driver who is in motion. Further, it is advantageous to stop the message a couple of seconds before the light changes so that the driver will look around before proceeding on a green light. In addition to road crossings and intersections, the present invention system is also useful for longer waits, such as train crossings and open bridge closings, e.g., for tall boat traffic, gate openings, e.g., to park at a stadium, to drive onto a ferry, etc.

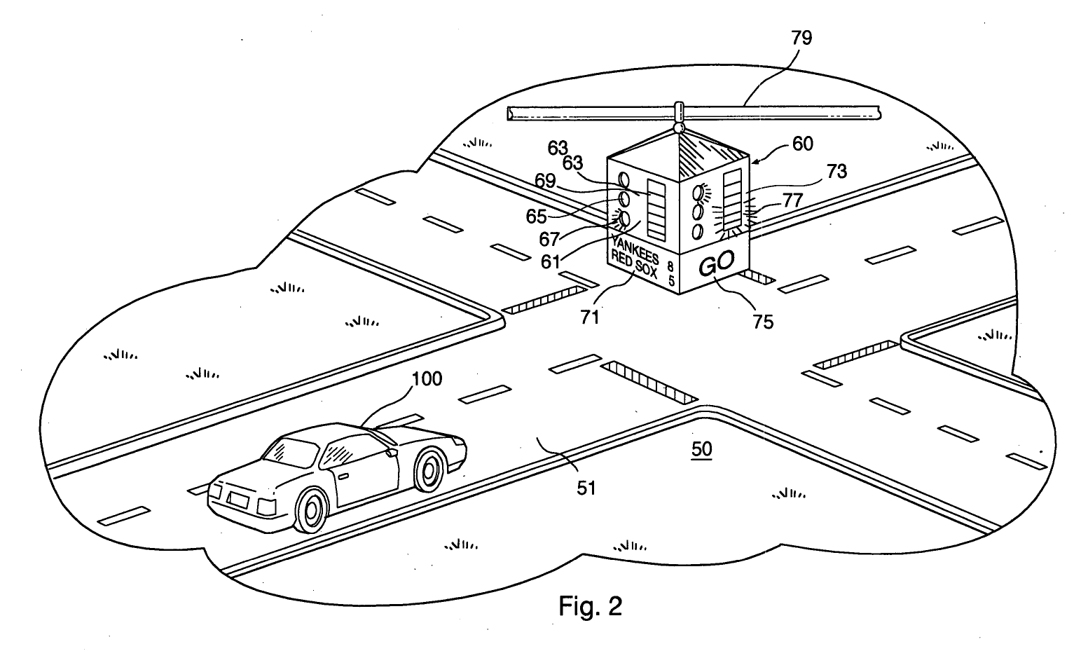

FIG. 2 is a perspective view of an intersection 50 with a present invention system traffic signal four way unit 60, locator at the center 53 of intersection 50. Vehicle 100 is approaching a stoplight (red light 67) on the inside lane 51, and is facing the west face 61 of unit 60. Face 61 has a green light 63, an amber light 65 and a red light 67 that operate in conventional traffic signal sequencing fashion. In this Figure, red light 67 on face 61 is illuminated and the driver of vehicle 100 is coming to a stop. At the same time, west face countdown display 69 is off and west face message screen 71 is streaming baseball score information, hence, providing information to drivers on the red light. Opposing east face (hidden) has parallel timing and lighting with the west face 61, while south face 73 of unit 60 has a green light illuminated as well as countdown display 77 partially illuminated, indicating relative time remaining before the green light turns red. Also, south face 73 has a message screen that has no streaming information and merely displays an optional “GO” message, or it could be blank or black. There is an opposing north face (hidden) with similar timing and presentations to the south face 73. Although not shown, additional signal features, such as delayed green, etc. could also be included and the countdown and message displays would be controlled accordingly.

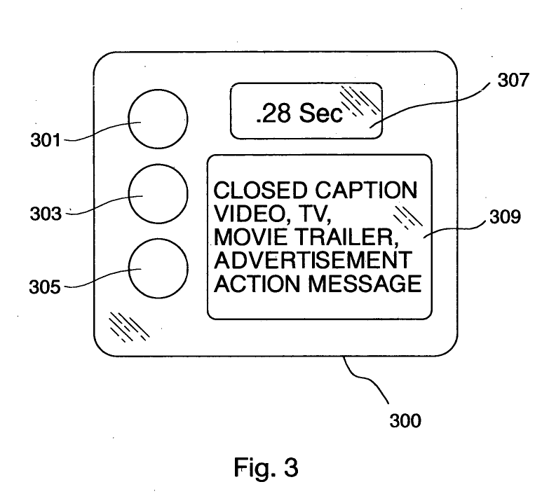

FIG. 3 is an enlarged front view of a traffic signal unit 300 of the present invention system with a remote controller (not shown) similar to those described above. In this embodiment, there are three standard traffic lights 301, 303 and 305, as well as captioned video, pictorial and word advertising and other complex presentations beyond word streams included in the message screen 309. Also, instead of a relative symbolic countdown feature, this embodiment includes a real time digital readout countdown clock 307.

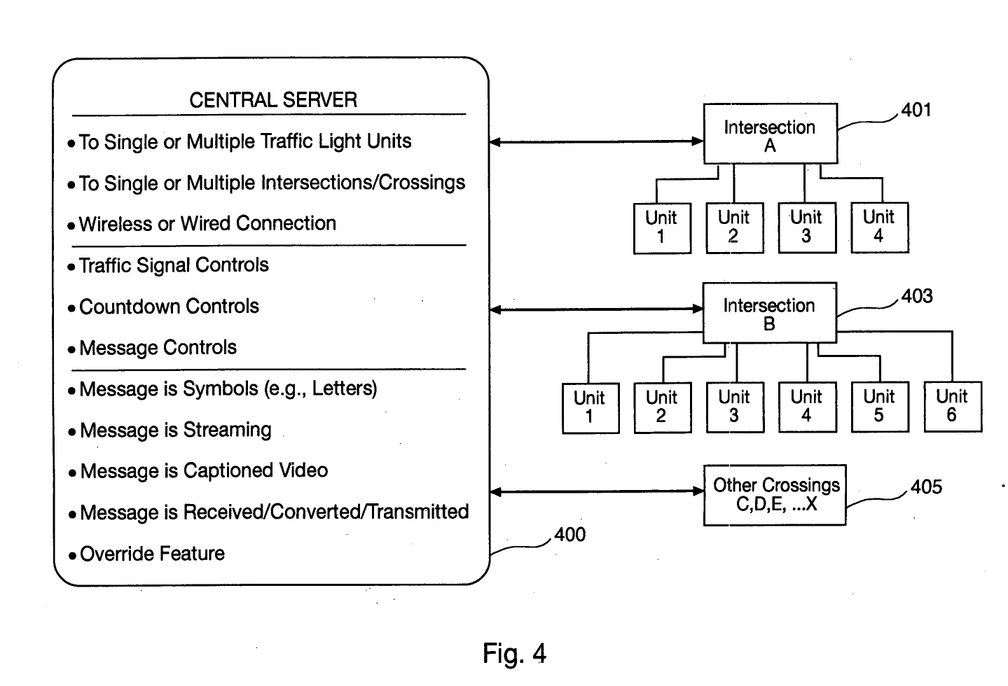

FIG. 4 shows a diagrammatic presentation of a macrosystem for multiple crossings with multiple features. The details of the units may be any described above, with the proviso that there be at least a red light that goes on and off, a countdown display that signals in real or relative time the oncoming red light, and a message display that provides more than just countdown information. Block 400 illustrates many of the features essential and optional features, block 401 represents Intersection A with four light units, block 403 represents Intersection B with six different light units and block 405 represents X number of additional intersections with multiple or single light units. In this embodiment, the central server may include any of the features described above, e.g. radio or TV broadcast receivers, and may be operated, for example, by a municipality that may generate significant advertising revenues from this system, as well as provide public service and other information and entertainment. The essential features and choices of these features are illustrated in block 400 of the Figure. Advantageously, the central server could be remotely or centrally located and operated via any available transmission possibilities (satellite, internet, phone landlines, wireless, dedicated) and receive inputs from any available desired source for messages.

To summarize, the present invention thus provides a unique opportunity to present any type of information and visual format to a captive audience (stopped drivers and passengers) while eliminating boredom or idle wait times, and also presenting revenue generating opportunities to government from purchased advertising messages.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

What is claimed is:

1. A traffic signal system with countdown signaling and with message, comprising:
a) at least one traffic signal located at a motor vehicle crossing including:
(i) a traffic signal light that includes at least a red light;
(ii) a countdown display that visually indicates relative or actual time remaining before a signal change is to occur;
(iii) a message display for presenting messages in a changing fashion to present messages that are not countdown information;
b.) a control means connected to said traffic signal including:
(i) light control means for turning said red light off and on in accordance with preset criteria;
(ii) countdown control means connected with said light control means and connected to said countdown display, and set to present time remaining before a signal change is to occur;
c.) a message control means connected to said message display to send and control the presentation of said messages.

2. The traffic signal system with countdown signaling and with message according to claim 1, wherein said messages on said message display are selected from the group consisting of graphic images, words and combinations thereof.

3. The traffic signal system with countdown signaling and with message according to claim 1, wherein said messages are streaming words.

4. The traffic signal system with countdown signaling and with message according to claim 1, wherein said messages are presented in sequential groups of messages or sequential portions of messages.

5. The traffic signal system with countdown signaling and with message according to claim 1, wherein said messages are selected from the group consisting of entertainment messages, news messages, information messages, public information and announcement messages, advertising and combinations thereof.

6. The traffic signal system with countdown signaling and with message according to claim 1, wherein said messages are transmitted display of motion presentation with closed caption.

7. The traffic signal system with countdown signaling and with message according to claim 6, wherein said motion presentation is a closed caption presentation selected from the group consisting of video, computer generated motion presentation and television.

8. The traffic signal system with countdown signaling and with message according to claim 1, wherein said countdown display is selected from the group consisting of a symbolic representation of relative time remaining, a numerical presentation of actual time remaining and a combination thereof.

9. The traffic signal system with countdown signaling and with message according to claim 1, wherein said traffic signal light includes at least a red light and a green light and the countdown display functions when the green light is lit and the message display functions when the red light is lit.

10. The traffic signal system with countdown signaling and with message according to claim 1, wherein said message display control means includes a government override feature for public emergency messages to supercede normal message display.

11. A traffic signal system with countdown signaling and with message, comprising:
a.) at least one traffic signal located at a motor vehicle crossing including:
(iv) a traffic signal light that includes at least a red light;
(v) a countdown display that visually indicates relative or actual time remaining before a signal change is to occur;
(vi) a message display for presenting messages in a changing fashion to present messages that are not countdown information;
b.) a control means connected to said traffic signal including:
(iii) light control means for turning said red light off and on in accordance with preset criteria;
(iv) countdown control means connected with said light control means and connected to said countdown display, and set to present time remaining before a signal change is to occur;
c.) a message control means wirelessly connected to said message display to control and transmit the presentation of said messages wirelessly.

12. The traffic signal system with countdown signaling and with message according to claim 11, wherein said messages on said message display are selected from the group consisting of graphic images, words and combinations thereof.

13. The traffic signal system with countdown signaling and with message according to claim 11, wherein said messages are streaming words.

14. The traffic signal system with countdown signaling and with message according to claim 11, wherein said messages are presented in sequential groups of messages or sequential portions of messages.

15. The traffic signal system with countdown signaling and with message according to claim 11, wherein said messages are selected from the group consisting of entertainment messages, news messages, information messages, public information and announcement messages, advertising and combinations thereof.

16. The traffic signal system with countdown signaling and with message according to claim 11, wherein said messages are transmitted display of motion presentation with closed caption.

17. The traffic signal system with countdown signaling and with message according to claim 16, wherein said motion presentation is a closed caption presentation selected from the group consisting of video, computer generated motion presentation and television.

18. The traffic signal system with countdown signaling and with message according to claim 11, wherein said countdown display is selected from the group consisting of a symbolic representation of relative time remaining, a numerical presentation of actual time remaining and a combination thereof.

19. The traffic signal system with countdown signaling and with message according to claim 11, wherein said traffic signal light includes at least a red light and a green light and the countdown display functions when the green light is lit and the message display functions when the red light is lit.

20. The traffic signal system with countdown signaling and with message according to claim 11, wherein said message display control means includes a government override feature for public emergency messages to supercede normal message display.
